(19) United States
(12) Patent Application Publication
(10) Pub. No.: US 2025/0246824 A1
(43) Pub. Date: Jul. 31, 2025

(54) Terminal Block with Holder

(71) Applicant: Tyco Electronics AMP Korea Co., Ltd., Gyeongsan (KR)

(72) Inventors: Byung-Hee Cho, Gyeongsan-Si (KR); Sung-Chul Kim, Gyeongsan-Si (KR)

(73) Assignee: Tyco Electronics AMP Korea Co., Ltd., Gyeongsan (KR)

(21) Appl. No.: 19/041,115

(22) Filed: Jan. 30, 2025

(30) Foreign Application Priority Data
Jan. 30, 2024 (KR) 10-2024-0014167

(51) Int. Cl. H01R 9/24

(52) U.S. Cl. CPC H01R 9/2416

(57) ABSTRACT

A terminal block with a holder member includes a block housing having two fixing slots into which two plate terminals are installable. The holder member has a fastening member adapted to fix the two plate terminals and a ring terminal. A holder housing of the holder member maintains a state in which the fastening member passes through the holder housing and is couplable to the block housing.

### CROSS-REFERENCE TO RELATED APPLICATION

This application claims the benefit of Korean Patent Application No. 10-2024-0014167 filed on Jan. 30, 2024, in the Korean Intellectual Property Office, the entire disclosure of which is incorporated herein by reference for all purposes.

### FIELD OF THE DISCLOSURE

The disclosure relates to a terminal block including a holder member adapted to prevent a loss of a fastening member that fixes a ring terminal.

### BACKGROUND OF THE INVENTION

In the prior art, terminal blocks for installing ring terminals are included in home appliances, such as dryers or ovens. Existing terminal blocks have different structures adapted to receive both ring terminals and/or strip wires. Currently, it is not possible to properly install both a strip wire and a ring terminal depending on circumstances on the same type of terminal block. In addition, to fix existing ring terminals to terminal blocks, bolts are used, and a worker fixes a ring terminal to a terminal block using a hand tool such as a screwdriver, and the like. During such work, a bolt for fixing the ring terminal may be lost. Due to the loss of the bolt, standard bolts that do not meet specifications may be used in place thereof, which may make it difficult to tightly fix the ring terminal. This results in not only the potential for unreliable or failed connections, but further, a risk fire, and the like.

### SUMMARY OF THE INVENTION

According to an embodiment of the present disclosure, a terminal block with a holder member includes a block housing having two fixing slots into which two plate terminals are installable. The holder member has a fastening member adapted to fix the two plate terminals and a ring terminal. A holder housing of the holder member maintains a state in which the fastening member passes through the holder housing and is couplable to the block housing.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is a perspective view of a terminal block with a holder member according to an embodiment;

FIG. 2 is a front view of the terminal block of FIG. 1;

FIG. 3 is an exploded perspective view of the terminal block of FIG. 1;

FIGS. 4A and 4B are plan views of plate terminals according to an embodiment;

FIG. 5 is a perspective view of a block housing according to an embodiment; and

FIG. 6 is an exploded perspective view of a holder member according to an embodiment.

### DETAILED DESCRIPTION

Hereinafter, embodiments will be described in detail with reference to the accompanying drawing. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments with reference to the accompanying drawing, like reference numerals refer to like components and a repeated description related thereto will be omitted. In the description of embodiments, detailed description of well-known related structures or functions will be omitted when it is deemed that such description will cause ambiguous interpretation of the present disclosure.

Furthermore, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected,” “coupled,” or “attached” to another constituent element, it should be understood that one constituent element can be connected or attached directly to another constituent element, and an intervening constituent element can also be “connected,” “coupled,” or “attached” to the constituent elements.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

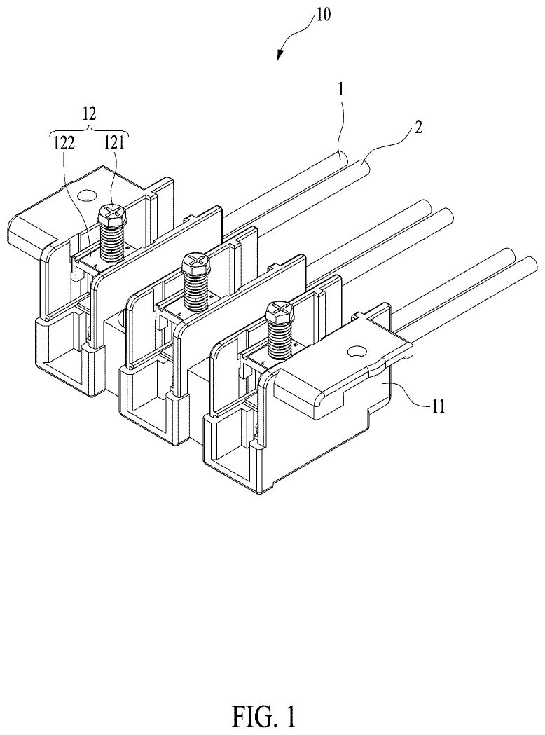

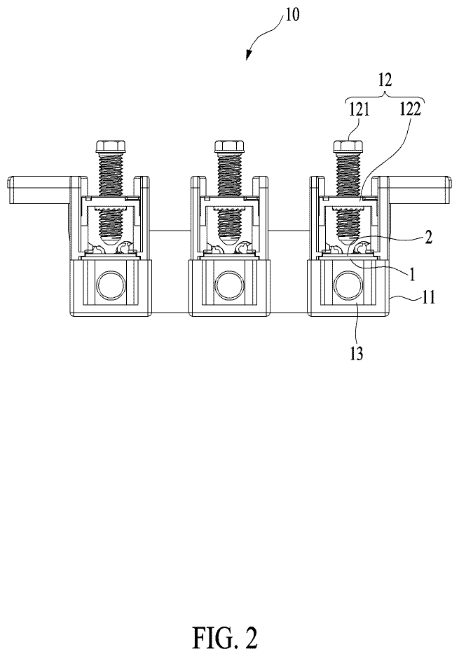

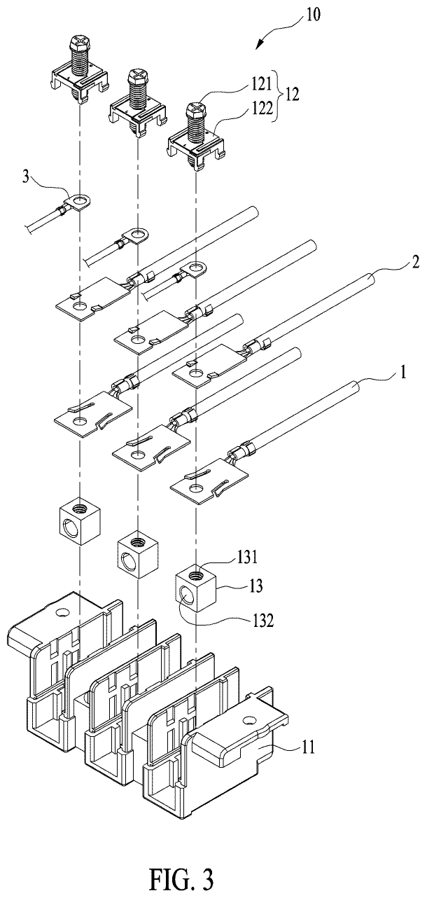

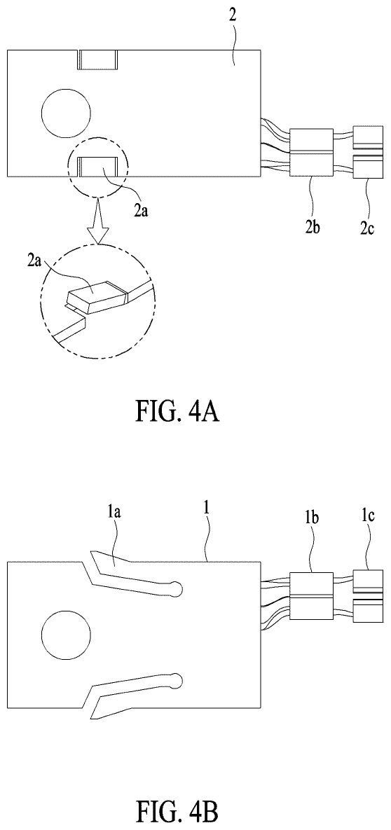

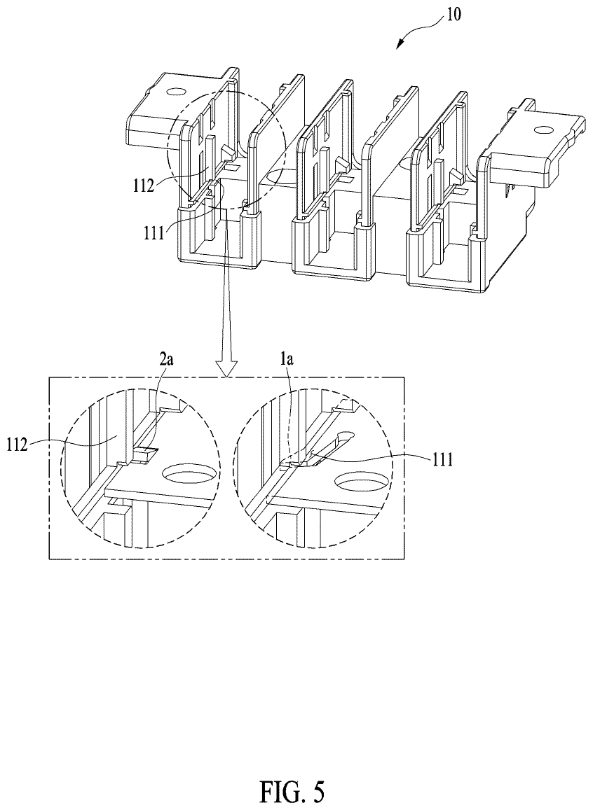

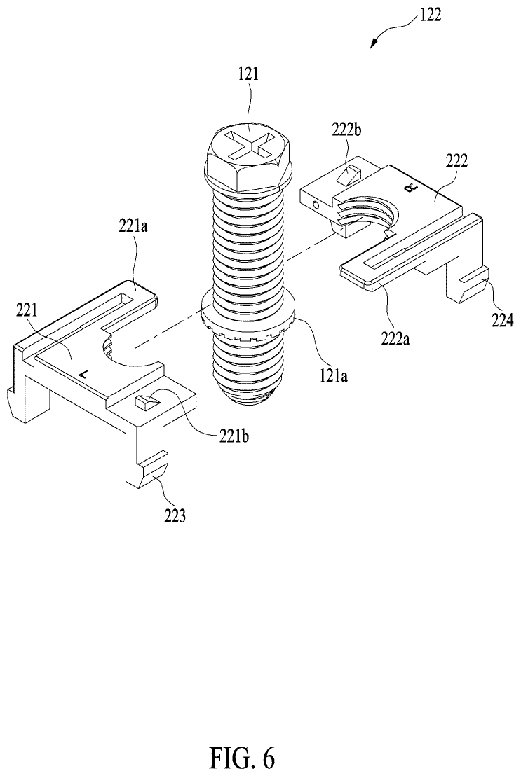

Hereinafter, a terminal block 10 with a holder member 12 is described with reference to FIGS. 1-6. FIG. 1 is a perspective view of a terminal block 10 according to an embodiment. FIG. 2 is a front view of the terminal block 10 of FIG. 1. FIG. 3 is an exploded perspective view of the terminal block 10 of FIG. 1. In addition, FIGS. 4A and 4B are plan views of a first plate terminal 1 and a second plate terminal 2 according to an embodiment. FIG. 5 is a perspective view of a block housing 11 according to an embodiment. FIG. 6 is an exploded perspective view of a holder member 12 according to an embodiment.

Referring to the drawings, the terminal block 10 includes the block housing 11, in which the first plate terminal 1 and the second plate terminal 2 are mounted, and the holder member 12 configured to fix a ring terminal 3. The block housing 11 may be formed such that the first plate terminal 1 and the second plate terminal 2 may be mounted therein. For example, the inside of the block housing 11 may be partitioned into a plurality of spaces such that a plurality of plate terminals, e.g., the first plate terminal 1 and the second plate terminal 2, may be separately mounted therein.

The first plate terminal 1 and the second plate terminal 2 may include, for example, two types of plate terminals with fixing pieces la and 2a having different shapes. In an example, a fixing piece la of a first plate terminal 1 may be formed to protrude outwards from both sides such that a side of a first plate terminal 1 may be fixed to an inner side surface of the block housing 11. In addition, a fixing piece 2a of a second plate terminal 2 may protrude upwards such that an upper side of a second plate terminal 2 may be fixed to the inner side surface of the block housing 11.

In the block housing 11, two fixing slots, e.g., a first fixing slot 111 and a second fixing slot 112, to which the fixing piece la of the first plate terminal 1 and the fixing piece 2a of the second plate terminal 2 are fixable may be formed. For example, in the block housing 11, the first fixing slot 111 may be formed on the inner side surface of the block housing 11 such that the fixing piece la of the first plate terminal 1 may be inserted into and caught by the first fixing slot 111, and the second fixing slot 112 may be formed to protrude inwards from the inner side surface of the block housing 11 such that the fixing piece 2a of the second plate terminal 2 may be caught by the second fixing slot 112.

In addition, since the fixing piece la of the first plate terminal 1 and the fixing piece 2a of the second plate terminal 2 have different shapes, the second plate terminal 2 may be stacked on the first plate terminal 1. Here, a stack order of the first plate terminal 1 and the second plate terminal 2 may not change. When the first plate terminal 1 and the second plate terminal 2 are stacked in the block housing 11, wire barrels 1b and 2b and insulation barrels 1c and 2c, through which wires are coupled, may be formed to be misaligned so as not to interfere with each other in the first plate terminal 1 and the second plate terminal 2, respectively. For example, the wire barrel 1b and the insulation barrel 1c of the first plate terminal 1 may be formed on the right side, and the wire barrel 2b and the insulation barrel 2c of the second plate terminal 2 may be formed on the left side. However, the drawings merely illustrate an example of the first plate terminal 1 and the second plate terminal 2, and positions of the wire barrel 1b and the insulation barrel 1c of the first plate terminal 1 and the wire barrel 2b and the insulation barrel 2c of the second plate terminal 2 may substantially vary.

The holder member 12 may include a fastening member 121 configured to fix the ring member 3 to the first plate terminal 1 and the second plate terminal 2, and a holder housing 122 formed to be coupled to the block housing 11. The fastening member 121 may pass through the holder housing 122 and extend by a predetermined length downwards from the holder housing 122. In addition, the fastening member 121 may be formed integrally with a washer portion 121a that fixes the ring terminal 3 or a strip wire (not shown).

The holder member 12 may be coupled to an upper portion of a stack of the first plate terminal 1, the second plate terminal 2, and the ring terminal 3. In other words, when the holder housing 122 is coupled to the block housing 11, the fastening member 121 of the holder member 12 may pass through and fix the ring terminal 3, the first plate terminal 1, and the second plate terminal 2, above the ring terminal 3. The holder housing 122 may substantially have a shape of a plate such that the fastening member 121 may pass through a central portion of the holder housing 122 and may be formed with two split members formed to face each other with respect to the fastening member 121.

When split members 221 and 222 are coupled to the fastening member 121, the split members 221 and 222 may be formed in a shape of a plate through which the fastening member 121 vertically passes. In addition, the split members 221 and 222 may be formed such that a portion in which the split members 221 and 222 are coupled may be flat. The split members 221 and 222 may include first locking portions 221a and 222a and second locking portions 221b and 222b that may be coupled to each other and may have shapes that are symmetrical to each other. For example, in the split members 221 and 222, the first locking portions 221a and 222a may have shapes of hooks extending from one side to another side, and the second locking portions 221b and 222b may have shapes of protrusions to which the first locking portions 221a and 222a on the other side may be hooked and engaged. Here, the split members 221 and 222 may be formed such that the first locking portions 221a and 222a and the second locking portions 221b and 222b may form the same plate when engaged with each other. However, the drawings merely illustrate an example of the first locking portions 221a and 222a and the second locking portions 221b and 222b, and the above two split members 221 and 222 may be substantially changed in various ways if the split members 221 and 222 are engageable to form one plate. According to embodiments, since the holder housing 122 includes the two split members 221 and 222, it may be easy to assemble the holder housing 122 and the fastening member 121.

The holder housing 122 may include coupling portions 223 and 224 formed on both sides to be coupled to the block housing 11. For example, the coupling portions 223 and 224 may have a shape of a hook formed on end portions of both sides of the holder housing 122. In addition, the coupling portions 223 and 224 may be formed to be symmetrical to the split members 221 and 222.

A block terminal 13 may stably fix the first plate terminal 1, the second plate terminal 2, the ring terminal 3, and the holder member 12. The block terminal 13 may be disposed between the block housing 11 and the first plate terminal 1, and a fastening hole 131 into which the fastening member 121 is fastened may be formed in the block terminal 13. In addition, a wire coupling hole 132 may be formed on one side of the block terminal 13. When a strip wire is inserted into the wire coupling hole 132 and when the fastening member 121 is fastened into the fastening hole 131, the block terminal 13 may be fixed and electrically connected.

For example, in a state in which the first plate terminal 1, the second plate terminal 2 and the ring terminal 3 are mounted on the block terminal 13 and the holder member 12 is coupled to the block housing 11, when the fastening member 121 is fastened into the fastening hole 131 of the block terminal 13 by passing through the first plate terminal 1, the second plate terminal 2 and the ring terminal 3, the first plate terminal 1, the second plate terminal 2, and the ring terminal 3 may be fixed and electrically connected to the block terminal 13 at the same time. In addition, in a state in which a strip wire (not shown) is inserted into the block terminal 13, the fastening member 121 may fix and electrically connect the first plate terminal 1, the second plate terminal 2, the ring terminal 3, and the strip wire. As the fastening member 121 configured to fix the ring terminal 3 is included in the holder member 12, the risk of losing the fastening member 121 during fixing of the ring terminal 3 may be prevented.

While the embodiments are described with reference to the drawing, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

1. A terminal block, comprising:
a block housing including two fixing slots into which two plate terminals are installable; and
a holder member including:
a fastening member adapted to fix the two plate terminals and a ring terminal; and
a holder housing adapted to maintain a state in which the fastening member passes through the holder housing and that is adapted to be coupled to the block housing.

2. The terminal block of claim 1, wherein the holder housing is formed with two split members that are engaged in a shape of a plate through which the fastening member vertically passes.

3. The terminal block of claim 2, wherein the two split members are formed to oppose one another and capture the fastening member therebetween.

4. The terminal block of claim 3, wherein each of the two split members includes a first locking portion and a second locking portion, the first locking portion extending from a first one of the two split members and engaging with the second locking portion of a second one of the two split members.

5. The terminal block of claim 4, wherein each of the two split members comprises a coupling portion that is adapted to latch to the block housing.

6. The terminal block of claim 2, wherein the fastening member is formed integrally with a washer portion.

7. The terminal block of claim 6, wherein the washer portion is disposed below the holder housing to fix the ring terminal and to prevent the fastening member from disengaging with the holder housing.

8. The terminal block of claim 1, wherein the plate terminals include a first terminal with first fixing pieces formed to protrude towards each of two lateral sides thereof.

9. The terminal block of claim 8, wherein the plate terminals further include a second terminal with second fixing pieces formed to protrude upwards.

10. The terminal block of claim 9, wherein the block housing includes a first fixing slot to which the first plate terminal with the first fixing pieces are fixable.

11. The terminal block of claim 10, wherein the block housing further includes a second fixing slot to which the second plate terminal with the second fixing pieces protruding upwards is fixable.

12. The terminal block of claim 11, wherein the block housing, and the first and second fixing slots, are adapted such that the second plate terminal is stackable on the first plate terminal.

13. The terminal block of claim 12, wherein when the first plate terminal and the second plate terminal are stacked, a wire barrel and an insulation barrel of the first plate terminal, and a wire barrel and an insulation barrel of the second plate terminal are formed in offset positions to prevent the wire barrels and the insulation barrels from interfering with each other.

14. The terminal block of claim 1, further comprising a block terminal disposed between the block housing and the plate terminals and coupled to the fastening member.

15. The terminal block of claim 14, wherein the block terminal comprises:
a fastening hole into which the fastening member is fastened; and
a wire coupling hole into which a strip wire is inserted and fixed.

16. A terminal block, comprising:
a block housing including two fixing slots into which two plate terminals are adapted to be installed; and
a holder member including:
a threaded fastening member adapted to fix the two plate terminals and a ring terminal to the block housing; and
a holder housing into which the threaded fastening member is threadably engaged, the holder housing coupled to the block housing and capturing the threaded fastening member such that it is maintained in threaded engagement with the holder housing.

17. The terminal block of claim 16, wherein the holder housing is formed with two split members selectively lockable together and through which the threaded fastening member vertically passes via threaded engagement with the holder housing.

18. The terminal block of claim 17, wherein the fastening member includes a washer portion arranged beneath the holder housing, the washer portion adapted to prevent the fastening member from threadably disengaging with the holder housing with the two split members locked together, and to engage with the ring terminal.

19. The terminal block of claim 16, further comprising a block terminal disposed between the holder housing and the block housing, including:
a fastening hole into which the fastening member is threadably engaged; and
a wire coupling hole in communication with the fastening hole, the wire coupling hole adapted to receive a strip wire and to fix the strip wire therein via the fastening member.

20. The terminal block of claim 16, wherein the block housing includes:
a first fixing slot into which a first plate terminal of the two plate terminals is fixable; and
a second fixing slot into which a second plate terminal of the two plate terminals is fixable in a stacked orientation relative to the first plate terminal.
